(19) United States
(12) Patent Application Publication
(10) Pub. No.: US 2024/0369029 A1
(43) Pub. Date: Nov. 7, 2024

(54) IMPROVED HYDROGEN INJECTION SYSTEM HAVING TWO GAS INJECTORS PER COMBUSTION CHAMBER

(71) Applicant: Robert Bosch GmbH, Stuttgart (DE)

(72) Inventors: Matthias Boee, Ludwigsburg (DE); Frank llgner, Stuttgart (DE)

(21) Appl. No.: 18/554,608

(22) PCT Filed: Jan. 21, 2022
(86) PCT No.: PCT/EP2022/051294

§ 371 Date: Oct. 9, 2023

(30) Foreign Application Priority Data
Mar. 11, 2021 (DE) 10 2021 202 390.8

(51) Int. Cl. F02M 21/02; F02D 41/30

(52) U.S. Cl. CPC F02M 21/0248; F02D 41/3005; F02M 21/0206

(57) ABSTRACT

A hydrogen injection system for an internal combustion engine having an intake pipe and a combustion chamber. The system includes a first gas injector, which is configured to carry out an injection of hydrogen into the intake pipe of the internal combustion engine, and a second gas injector, which is configured to carry out an injection of hydrogen directly into a combustion chamber of the internal combustion engine.

### FIELD

The present invention relates to a hydrogen injection system for an internal combustion engine operated using hydrogen, the system having two gas injectors per combustion chamber and exhibiting an improved operating behavior at a reduced hydrogen consumption.

### BACKGROUND INFORMATION

In recent years, increasing attempts have been made to use hydrogen as fuel for internal combustion engines. Two basic concepts are pursued in the hydrogen injection in this context, i.e., an injection via an intake pipe on the one hand, or a direct injection of hydrogen into a combustion chamber of the internal combustion engine on the other hand. In addition, internal combustion engines are described in the related art, for instance in German Patent Application No. DE 10 2008 041 239 A1, which describes two injection valves for liquid fuel. However, a direct implementation of such concepts for internal combustion engines using liquid fuels is unable to be realized in an injection of gaseous hydrogen because different marginal conditions prevail on account of the gaseous hydrogen. An air displacement occurs in an injection of gaseous hydrogen into an intake pipe so that a maximally achievable cylinder output is restricted. In a direct injection of gaseous hydrogen into a combustion chamber, such directly injecting gas injectors must have very large sealing seat cross-sections to even allow for an injection of hydrogen directly into the combustion chamber with high injector dynamics at short opening and closing times. Furthermore, such directly injecting gas injectors and injection concepts are extremely challenging to the extent that they are realizable at reasonable costs in the first place. It would therefore be desirable to have a better option for introducing gaseous hydrogen into an internal combustion engine.

### SUMMARY

A hydrogen injection system for an internal combustion engine according to the present invention may offers an advantage of allowing for an improved hydrogen injection in all load states of the internal combustion engine. The hydrogen injection system according to the present invention may have a very simple design and be realized in a cost-effective manner. In addition, an improved mixture formation between hydrogen and oxygen is able to be achieved in the operation of the internal combustion engine and a consumption of the internal combustion engine be reduced. According to an example embodiment of the present invention, this may be achieved in that the hydrogen injection system has a first and a second gas injector. The first gas injector is designed to carry out an injection of hydrogen into an intake pipe of the internal combustion engine. The second injector is designed to carry out an injection of hydrogen directly into a combustion chamber of the internal combustion engine. This makes it possible to carry out an injection using only one of the gas injectors or using both gas injectors, in particular as a function of a load state of the internal combustion engine.

Great advantages may be achieved according to the present invention, especially in the metering of small quantities of hydrogen such as during an idling operation or a lower partial-load range, because a rapid initial-pressure control, which has to adapt the pressure control in accordance with the load states in an operation of the internal combustion engine, is often indispensable in a pure system for a direct injection.

Preferred further refinements and example embodiment of the present invention are disclosed herein.

In addition, the hydrogen injection system according to an example embodiment of the present invention preferably includes an ignition device such as a spark plug. This makes it possible to operate the internal combustion engine according to the Otto principle.

Moreover, according to an example embodiment of the present invention, a first injection pressure of the first gas injector for the intake pipe is preferably lower than a second injection pressure of the second gas injector for the direct injection into the combustion chamber. The first injection pressure lies in a range of preferably 3×10⁵ Pa to 7×10⁵ Pa and preferably amounts to approximately 5×10⁵ Pa. The second injection pressure of the second gas injector preferably lies in a range of 15×10⁵ Pa to 30×10⁵ Pa and preferably amounts to approximately 25×10⁵ Pa.

According to an example embodiment of the present invention, an especially simple and cost-effective design is possible if the first injection pressure of the first gas injector and/or the second injection pressure of the second gas injector is constant during the operation in each case. The first and second injection pressure are preferably of an equal magnitude.

According to a further preferred embodiment of the present invention, the hydrogen injection system also includes a control unit, which is designed to control a hydrogen injection with the aid of the first gas injector and/or the second gas injector as a function of a load state of the internal combustion engine.

According to an example embodiment of the present invention, the control unit is preferably designed in such a way that in an idling operation and in a lower partial-load range of the internal combustion engine, up to approximately 50% of a full load, hydrogen is injected exclusively with the aid of the first gas injector. In addition, the control unit is preferably designed to inject the hydrogen with the aid of the first gas injector and the second gas injector in the remaining load state of the internal combustion engine, that is to say, when the load state lies above the limit of the lower partial-load range (approximately 50% of the full load). As a result, the difficult and rapid initial-pressure control in the direct injection is able to be omitted because the injection in the lower load range or in the idling operation range can be carried out via only the first gas injector. At higher load states, both gas injectors are then preferably used so that the required hydrogen quantity per combustion cycle is able to be injected into the combustion chamber. Especially also the second gas injector, which injects the hydrogen directly into the combustion chamber, may therefore have a significantly smaller design, which means that corresponding cost savings are realizable, in particular for this gas injector.

According to an example embodiment of the present invention, especially preferably, the first and second gas injector have an identical development. This allows for a more cost-effective production of the gas injectors as a mass-produced part.

In addition, according to an example embodiment of the present invention, the hydrogen injection system preferably also includes a shared hydrogen reservoir and a line system for supplying the hydrogen to the first and second gas injector. A first pressure controller is situated in a supply line to the first gas injector, and a second pressure controller is situated in a supply line to the second gas injector. The pressure controllers reduce the very high pressure of approximately 700×10⁵ Pa, under which hydrogen is usually stored, to the appropriate required pressure levels for the first and second gas injector. The first and/or second pressure controller(s) is/are preferably adjustable in order to allow for a pressure control of the hydrogen supplied to the first and second gas injector. A mechanical pressure controller is preferably used for a constant pressure, and an electric pressure controller is used for a variable pressure.

In addition, according to an example embodiment of the present invention, the control unit is preferably designed to implement an injection pressure and/or an opening duration of the first and second gas injector as a function of a load state of the internal combustion engine.

The present invention additionally relates to an internal combustion engine having a hydrogen injection system according to the present invention. According to an example embodiment of the present invention, the internal combustion engine is preferably developed in such a way that the second gas injector is situated in the center or to the side of the combustion chamber in a cylinder head of the internal combustion engine.

In addition, the present invention relates to a method for operating an internal combustion engine using gaseous hydrogen as fuel, and a first gas injector is provided to inject the hydrogen into an intake pipe and a second gas injector is provided to inject the hydrogen directly into a combustion chamber of the internal combustion engine. According to an example embodiment of the present invention, the method carries out the hydrogen injection in such a way that an injection is implemented exclusively by only one of the gas injectors or by both gas injectors as a function of the load state of the internal combustion engine.

In an idling operation and in a lower partial-load range, the method according to an example embodiment of the present invention preferably carries out the gas injection of hydrogen using only the first injector, which injects into the intake pipe. In all other load ranges above the limit from the lower partial-load range and also at a full load, the method implements the hydrogen injection with the aid of both gas injectors or only with the aid of the second gas injector.

It should be mentioned that the lower partial-load range lies between the idling operation of the internal combustion engine and approximately 50% of the full load, preferably 20% of the full load of the internal combustion engine.

### BRIEF DESCRIPTION OF THE DRAWING

In the following text, a preferred exemplary embodiment of the present invention is described in detail with reference to the FIGURE.

FIG. 1 shows a schematic representation of an internal combustion engine having a hydrogen injection system according to a preferred exemplary embodiment of the present invention.

### DETAILED DESCRIPTION OF EXAMPLE EMBODIMENTS

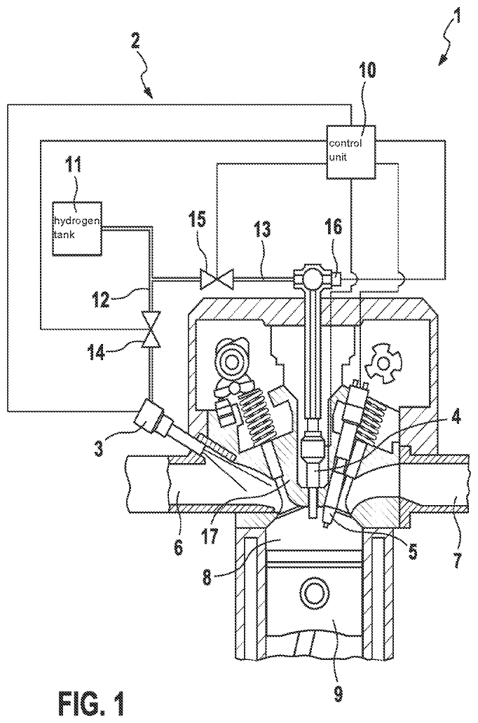

In the following text, an internal combustion engine 1 having a hydrogen injection system 2, and a method for injecting hydrogen into an internal combustion engine according to the present invention will be described with reference to FIG. 1.

As may be gathered from the schematic view of FIG. 1, internal combustion engine 1 includes an intake pipe 6, which leads to a combustion chamber 8, and an exhaust pipe 7, which leads away from combustion chamber 8. A piston 9 is situated in a cylinder in a conventional manner. Internal combustion engine 1 also includes an ignition device 5, which is a spark plug in this exemplary embodiment.

In addition, hydrogen injection system 2 includes a first gas injector 3 and a second gas injector 4. First gas injector 3 is situated so that gaseous hydrogen is injected into intake pipe 6. Second gas injector 4 is situated so that the gaseous hydrogen is able to be injected directly into combustion chamber 8. Second gas injector 4 is centrally disposed in a cylinder head 17 of the internal combustion engine. As an alternative, it is also possible to position the second gas injector laterally on the combustion chamber.

Hydrogen injection system 2 additionally includes a hydrogen tank 11 as well as a line system for supplying the hydrogen to the first and second gas injector 3, 4. A main line 12 from hydrogen tank 11 to first gas injector 3 is provided as a supply line. In addition, a branch line 13, which branches off from main line 12 and leads to second gas injector 4, is provided.

A first pressure controller 14 is situated in main line 12 in the flow direction from hydrogen tank 11 to first gas injector 3 downstream from the branching of branch line 13. A second pressure controller 15 is additionally situated in branch line 13.

First and second pressure controllers 14, 15 are adjustable so that a pressure level of the hydrogen at first and second gas injector 3, 4 is able to be controlled.

In addition, a pressure sensor 16 is provided on second gas injector 4 in order to carry out a direct measurement of a pressure level in branch line 14 in the region of second gas injector 4.

Hydrogen injection system 2 furthermore includes a control unit 10. Control unit 10 is designed to control the hydrogen injection by the first and/or second gas injector as a function of a load state of internal combustion engine 1. As may be gathered from FIG. 1, control unit 10 is connected both to first and second gas injector 3, 4 and to first and second pressure controller 14, 15 and also to ignition device 5. In addition, pressure sensor 16 at branch line 13 also supplies corresponding pressure values in branch line 13 to control unit 10.

Control device 10 is preferably designed in such a way that in an idling operation and in a lower partial-load range, which is lower than 50% of the full load, the hydrogen injection is carried out exclusively with the aid of first gas injector 3 into intake pipe 6. A pressure level of the hydrogen for the injection with the aid of first gas injector 3 preferably lies at approximately 5×10⁵ Pa. In the remaining load-state range, that is to say, at load states between the lower partial-load range and the full-load range, a hydrogen injection is carried out by both gas injectors 3, 4. A pressure level of second gas injector 4 preferably lies at 25×10⁵ Pa.

In addition, control unit 10 is preferably designed in such a way that for the injection, the injection durations and/or also the pressures of the hydrogen for the injection with the aid of the first and second gas injector 3, 4, are adapted as a function of the load state in each case. This makes it possible to realize the most optimal hydrogen injection as a function of the load state through the control of two variables.

According to the present invention, the problem in the hydrogen injection, i.e., that the pure direct injection of hydrogen is unable to satisfactorily provide the small quantities of hydrogen required in an idling operation and in the lower load range through a rapid initial-pressure control, is able to be solved in a surprisingly simple manner. As a result, an energy consumption of internal combustion engine 1 can be further reduced. In addition, it is also possible to achieve an optimized mixture formation as a function of the load state. Moreover, the problem that arises in pure intake-pipe injections, that is, the possible occurrence of undesired back-ignitions due to reduced hydrogen quantities in the intake pipe, is also solvable. In this context, the internal combustion engine may also be used for high rated engine outputs, for instance 120 KW per liter.

1-12. (canceled)

13. A hydrogen injection system for an internal combustion engine having an intake pipe and a combustion chamber, the hydrogen injection system comprising:
a first gas injector configured to carry out an injection of hydrogen into the intake pipe of the internal combustion engine; and
a second gas injector configured to carry out an injection of hydrogen directly into the combustion chamber of the internal combustion engine.

14. The hydrogen injection system as recited in claim 13, wherein: (i) an injection pressure of the first gas injector is lower than an injection pressure of the second gas injector, or (ii) the injection pressures of the first and second gas injector are of an equal magnitude.

15. The hydrogen injection system as recited in claim 14, wherein the injection pressure of the first gas injector and/or the second gas injector is constant in every load state of the internal combustion engine.

16. The hydrogen injection system as recited in claim 13, further comprising:
a control unit configured to control the hydrogen injection using the first gas injector and/or the second gas injector as a function of a load state of the internal combustion engine.

17. The hydrogen injection system as recited in claim 16, wherein in an idling operation and in a lower partial-load range of the internal combustion engine, the control unit is configured to inject hydrogen exclusively using the first gas injector into the intake pipe, and in a remaining load state of the internal combustion engine from a lower partial-load range to a full load, the control unit is configured to inject hydrogen: (i) using the first gas injector and the second gas injector, or (ii) exclusively using the second gas injector.

18. The hydrogen injection system as recited in claim 13, further comprising:
a hydrogen tank and a line system for supplying hydrogen to the first and second gas injector, and a first pressure controller is situated in a supply line to the first gas injector, and a second pressure controller is situated in a branch line to the second gas injector.

19. The hydrogen injection system as recited in claim 18, wherein the first pressure controller and/or the second pressure controller is adjustable to allow for a pressure control of the hydrogen supplied to the first gas injector and/or the second gas injector.

20. The hydrogen injection system as recited in claim 16, wherein the control unit is configured to:
implement an injection pressure of the hydrogen at the first and/or second gas injector as a function of the load state of the internal combustion engine, and/or implement an opening duration of the first and/or second gas injector as a function of the load state of the internal combustion engine.

21. An internal combustion engine, comprising:
an intake pipe and a combustion chamber; and
a hydrogen injection system including:
a first gas injector configured to carry out an injection of hydrogen into the intake pipe of the internal combustion engine, and
a second gas injector configured to carry out an injection of hydrogen directly into the combustion chamber of the internal combustion engine.

22. The internal combustion engine as recited in claim 21, wherein the second gas injector is centrally situated on a center line of the combustion chamber on a cylinder head of the internal combustion engine, or the second gas injector is laterally situated on the combustion chamber of the internal combustion engine.

23. A method for operating an internal combustion engine using gaseous hydrogen, the internal combustion engine having a first gas injector for injecting hydrogen into an intake pipe and a second gas injector for injecting hydrogen into a combustion chamber, the method comprising:
implementing an injection using exclusively only one of the first and second gas injectors as a function of a load state of the internal combustion engine, or
implementing an injection of hydrogen using both of the first and second gas injectors as a function of the load state of the internal combustion engine.

24. The method as recited in claim 23, wherein:
in an idling operation and in a lower partial-load range, which lies between an idling range and 50% of a full load, the injection is carried out only using the first gas injector into the intake pipe, and
in a load range starting from the lower partial-load range to the full load, hydrogen is injected using: (i) the first gas injector and the second gas injector, or (ii) exclusively using the second gas injector.
